(19) United States
(12) Patent Application Publication
(10) Pub. No.: US 2012/0170819 A1
(43) Pub. Date: Jul. 5, 2012

(54) Fingerprint Image Sensor without Residual Image

(75) Inventors: Shoichi Kiyomoto, Tokyo (JP); Shinil Cho, Allison Park, PA (US)

(73) Assignee: ASD, INCORPORATED, Tokyo (JP)

(21) Appl. No.: 13/009,196

(22) Filed: Jan. 19, 2011

(30) Foreign Application Priority Data
Jan. 5, 2011 (JP) 2011-000298

(51) Int. Cl. G06K 9/00

(52) U.S. Cl. 382/124

(57) ABSTRACT

The Problems

To dissipate or remove droplets of sweat fluid discharged from sweat glands of the finger placed on the sensor surface, which is the cause of the residual fingerprint image, from the surface of the fingerprint image sensor.

Means for Solving the Problem

On the surface of a fingerprint image acquisition sensor consisting of the electrode 2 of the minimum functional element separated with the grid 1, a coating layer on which the groove 30 is etched on the surface of the coating layer 32, running along the center of each grid line for draining the sweat fluid discharged from the sweat glands on the finger placed on the fingerprint image acquisition sensor.

### FIELD OF THE INVENTION

The present invention relates to a fingerprint image acquisition sensor that leaves virtually no residual fingerprint images by dissipating or removing droplets of sweat discharged from sweat glands of the finger placed on the sensor surface, which is the cause of the residual fingerprint image, from the surface of the fingerprint image sensor.

### BACKGROUND OF THE INVENTION

When a fingerprint is utilized as a means for biometrically authenticating the identity of a person, it is pointed out that an artificial (fake) finger may be presented to a biometric fingerprint sensor, know as a spoof attack (References 1-3). For example, at an international airport in Japan, a visitor who had a deportation record used a fake finger to pass through the immigration counter. The fake finger was a polymer membrane that copied a fingerprint of someone else. Similar crimes are also being committed in other countries.

A more sophisticated method for replicating a fingerprint image is to copy a residual fingerprint (Reference 4).

A residual fingerprint on a fingerprint image sensor at the time of acquiring a fingerprint image for authentication is the result of adherence of sweat fluid which is discharged from sweat grants locating along the fingerprint ridges to the surface of the sensor as shown in FIG. 4. The sweat fluid which remained on the surface of the fingerprint sensor forms the same pattern as the ridge lines of the fingerprint, resulting in the residual fingerprint image. This phenomenon is similar to the so-called “water mark” on the window glass (Reference 5).

The residual fingerprint image may be transferred to an oil absorbing sheet of high absorbance, which is used as artwork to make an artificial fingerprint pattern.

In the prior art, there are inventions for preventing a fingerprint image sensor from being formed a residual fingerprint image. For example, the Japanese Patent Application Kokai Patent Number 2008-117086 proposed a fingerprint image sensor that has an opening or a dent is formed where a finger is placed or being slid in order to achieve less contacting surface area.

However, for a fingerprint image sensor where a finger is placed stationary for a moment contacting with the sensor surface, elimination of the residual fingerprint image has remained as one of the challenging issues on the vulnerability of the biometric technology. Other issues caused by the adhered body fluid discharged from a finger includes: hygiene in which a next person who places his/her fingerprint may be exposed to the substance on the fingerprint image sensor from previous people, and the accuracy of matching a reference fingerprint image to a fresh fingerprint image in which the residual fingerprint image from a previous authentication may degrade the matching accuracy of a next event of authentication.

### SUMMARY OF THE INVENTION

### Problems that the Invention is to Solve

The inventors of the present invention have diligently conducted various experiments to dissipate or eliminate the residual fingerprint image. Since the essential cause of the residual fingerprint image is the droplets of sweat fluid discharged from a finger placed on the sensor surface, the investigation has focused on the degree of wetting the solid surface with water: low wetting due to high water dispersion and large interfacial tension while high wetting due to high water absorption, high water permeability, and low interfacial tension.

FIG. 6(a) depicts an interface between a hard-to-wet solid surface 3 of highly dispersive material and a liquid droplet 4, which forms a spherical or an ellipsoidal shape to form a large wetting angle θ5, due to the large interfacial tension. On the other hand, FIG. 6(b) depicts an interface between an easy-to-wet solid surface 3 of high water permeability and a liquid droplet, which hardly maintains its solid shape and forms a small wetting angle θ5 due to the small interfacial tension.

It is well-known to those in the nanotechnology industry that a coating material such as silicon nitride and silicon oxynitride for enhancing the surface hardness of a semiconductor fingerprint image sensor is wettable. When the surface is in contact with liquid such as sweat, the contact angle (i.e., the wetting angle θ5) becomes small. In this case, as shown in FIG. 2(b), the shape of the liquid holds and hence the residual fingerprint image due to the sweat substance forms remains on the sensor surface.

### Means for Solving the Problems

Considering the above technological issues, the first part of the present invention provides a fingerprint image sensor which is top-coated with a layer on which there are horizontal and vertical grooves formed taking the identical geometrical pattern to the grid lines which separate each electrode which is the minimum functional unit of the sensor.

The second part of the present invention provides another fingerprint image sensor coated with the aforementioned top-layer on which a thin film of anatase titanium oxide, known to be hyper-hydrophilic, is additionally deposited and formed horizontal and vertical grooves identical to the grid line pattern of the sensor thereon.

The above configuration may drain the sweat fluid into the grooves and eliminate or collapse the residual fingerprint image to prevent potential use of the residual fingerprint image maliciously.

The above coating layers with specially fabricated patterns may drain the sweat fluid which forms a residual fingerprint into the grooves to eliminate the pattern of the residual fingerprint effectively, which prevents the residual fingerprint image from being stolen for a malicious use.

Because the grooves for draining the sweat droplets is fabricated to form the identical pattern to the grid lines which are non-active part of the fingerprint image sensor, and held at zero electrical potential, the drained fluid is undetectable electrically to causes no effect on an acquired fingerprint image for a next event of the image acquisition. Therefore, the matching accuracy of fingerprint is not spoiled but enhanced.

In particular, because the second invention of the present invention has the additional thin film of hyper-hydrophilic anatase titanium oxide on which the grooves for draining the sweat fluid are engraved, the draining rate is faster and hence the elimination of the residual fingerprint image becomes quicker.

The grooves may be formed in both the horizontal and the vertical directions, or alternatively in either direction for establishing an easier cleaning procedure by swiping the drained water.

### EFFECT OF THE INVENTION

The present invention may drain sweat fluid droplets, which may form a residual fingerprint image, to eliminate the pattern of the residual fingerprint effectively for preventing the residual fingerprint image from being used maliciously. A the same time, the accuracy of matching fingerprint image will be improved.

### REFERENCES

1. D. Maltoni, D. Maio, A. K. Jaon, and S. Prabhakar, “ ”Handbook Handbook of Fingerprint Recognition” (2003, Springer)
2. A. K, Jain, P. Flynn, and Arun A. Ross (ed.), “Handbook of Biometrics” (2008, Springer)
3. M. Une and T. Matsumoto, “Vulnerability of Biometric Authentication System: Vulnerability to biometric counterfeit [symbol] [symbol] [symbol] [symbol] [symbol] [symbol] [symbol] [symbol] ,” No. 2, Vol. 2 (2005), Monetary and Economic Studies, Institute for Monetary and Economic Studies, Bank of Japan.
4. Tatsuya Sasaki, “Establishing a test environment for a fake fingerprint tolerance of a fingerprint authentication system [symbol] [symbol] [symbol] [symbol] [symbol] [symbol] ,” No. 1, Vol. 26 (2003), SOFTECH, CAC Corporation (www.cac.co.jp/softechs/pdf/st2601_{—}10.pdf)
5. T. Yasuzaki, “Unstainable Window Glass ( [symbol] [symbol] ,” No. 11, Vol. 26 (2005), Surface Science (http://www.jstage.jst.go.jp/article/jsssj/26/11/26_{—}700/_article/-char/ja)

### BRIEF DESCRIPTION OF THE DRAWINGS

FIG. 1 shows a general semiconductor fingerprint image sensor of the static electric capacity type where a finger is placed on the area of fingerprint image acquisition.

FIG. 2 is an enlarged diagram of the area of fingerprint image acquisition 11.

FIG. 3 depicts the cross-sectional view along the line A-A in FIG. 2 which shows an embodiment of the first invention of the present invention.

FIGS. 4(a) and 4(b) show a fingerprint image acquired by using the semiconductor fingerprint image sensor, and an enlarged view of part of FIG. 4(a).

FIG. 5 depicts the cross-sectional view of an embodiment of the second invention of the present invention, where the cross-sectional line is taken similar to FIG. 3.

FIG. 6 illustrates the wetting angle θ of liquid adhered to a solid surface where the solid is hard to be wet in FIG. 6(a) whereas it is easy to be wet in FIG. 6(b), respectively.

### DETAILED DESCRIPTION OF THE INVENTION

### Embodiment of the Invention

Embodiments of the present invention, which is a fingerprint image sensor coated with a layer on which there are horizontal and vertical grooves formed taking the identical geometrical pattern to the grid lines which separate each electrode which is the minimum functional unit of the sensor in order to drain sweat droplets discharged from sweat glands of a finger, are now disclosed in detail.

### Embodiment 1

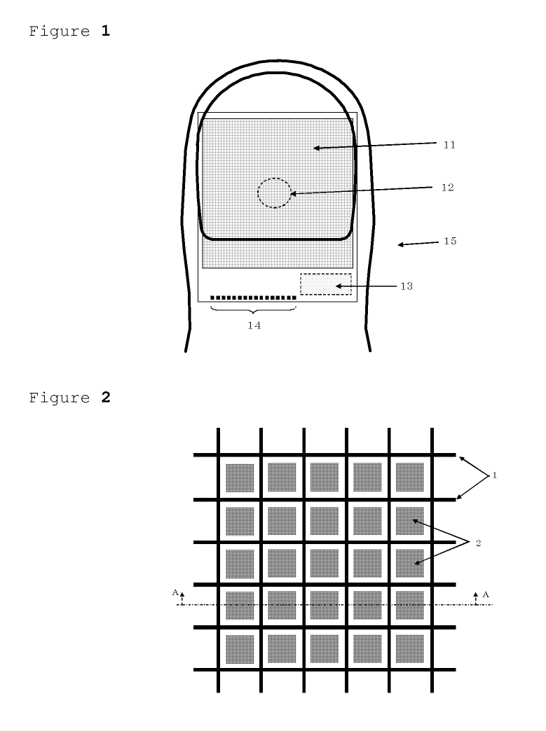

Referring to figures herein, the first embodiment of the semiconductor fingerprint image sensor of the present invention is described hereafter. FIG. 1 shows a general semiconductor fingerprint image sensor of static electric capacity type on which a finger is placed on the area of fingerprint image acquisition where 13 is the control unit and 14 is connection terminal with a peripheral circuits.

FIG. 2 is an enlarged diagram of the area of fingerprint image acquisition 11 where 2 the electrode which is the minimum functional unit to handle a signal output from a pixel, the element unit of a digital fingerprint image, and there are grid 1 between two adjacent electrodes 2 whose electric potential is kept zero. Generally speaking, the physical size of the electrode is approximately 40 μm×40 μm and the grid pitch is approximately 50 μm×50 μm.

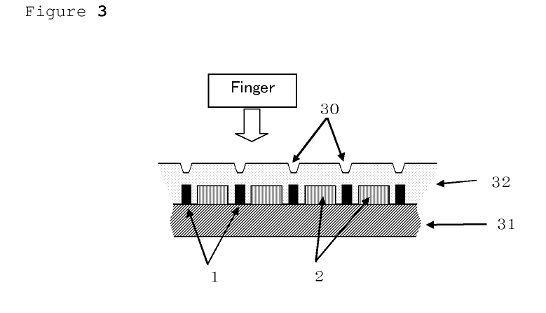

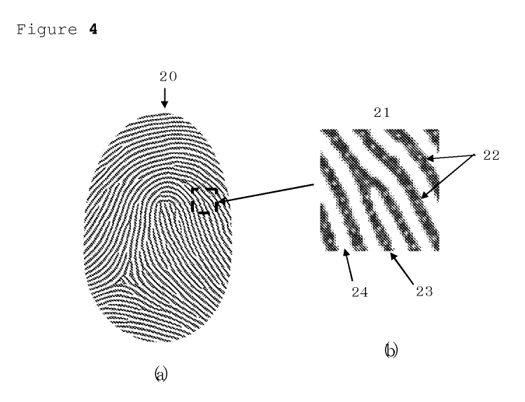

FIG. 3 depicts the cross-sectional view along the line A-A in FIG. 2 which shows an embodiment of the first invention of the present invention where the electrode 2 and the grid 1 are layered on the semiconductor substrate 31, which consists of multiple layers for various functions, of the embodiment of the first invention of the present invention, and the groove 30 of the width approximately 10 μm is etched on the surface of the coating layer 32, running along the center of each grid line by means of an appropriate method such as laser etching, sand blast, and diamond cutting.

FIGS. 4a and 4b show a fingerprint image 20 acquired by using the semiconductor fingerprint image sensor whose cross-sectional view is depicted as FIG. 3, and an enlarged image 21 of part of the image 20. In the image 21 of FIG. 4b, the ridge 23 and the valley 24 form part of fingerprint. Here the periodically aligning white dots on the ridge 23 are the sweat glands 22 from which sweat fluid is discharged to form a residual fingerprint. Statistically speaking, the mean value of the pitch of the ridge, which is defined as the structural period in the direction vertical to the ridges, is approximately 0.6 mm (600 μm), and the pitch of the sweat glands is approximately 200 μm.

Therefore, for a pair of the ridge and the valley lines, there are 12 electrodes that measure to the pattern of structural change to output electrical signal. A droplet of the sweat fluid which is discharged from a single sweat gland contacts with at least one grid line even excluding a possibility of condensing the droplets to become a larger size as time elapses.

When a finger touches the surface of the fingerprint image sensor, sweat fluid discharged from the sweat glands stay on the surface, which flows into the grooves 30 of the width 10 μm, collapsing the line of sweat droplets along the ridge. As the result, the residual fingerprint image will disappear to degrade the image impossible for use. The sweat drained into the groove 30 of the width 10 μm, formed on the grid 1 which has the zero electric potential, also has the null electric potential, and thus, the sweat is electrically undetectable to cause any significant effect on the image quality of a fingerprint acquired by the fingerprint image sensor. In other words, the accuracy of matching fingerprint image in the following event will be unaffected by residual fingerprint images.

The groove 30 may be formed only in a single direction, either horizontal or vertical. In other words, rather than engraving the grooves taking the identical pattern to the grid structure, a set of parallel lines, e.g., only the vertical lines, of the grooves 30 may be formed. With this one-directional configuration, cleaning the sensor surface by swiping becomes easier and more complete.

The engraving process to form the grove 30 on the coating layer 32 is performed prior to dicing a wafer of the sensor IC chips.

### Embodiment 2

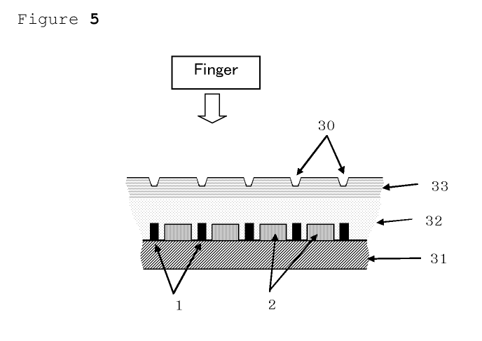

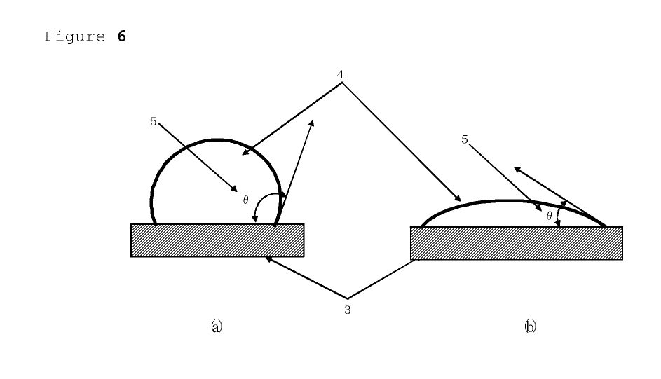

FIG. 5 depicts the cross-sectional view of an embodiment of the second invention of the present invention, where, similar to the first invention of the present invention, there are electrodes 2 and the grids 1 formed on the substrate 31 of the semiconductor fingerprint image sensor, covered with the coating layer 32, and then a the thin film of anatase titanium oxide 33 is additionally formed on the coating layer on which the grooves 30 are engraved for draining the sweat droplets

The method for depositing the anatase titanium oxide layer on the coating layer 32 may be the chemical vapor deposition (CVD). Namely, gas of an organic titanium compound as the raw material is supplied into the reaction chamber of reduced pressure to heat up with an external heater for decomposition (which is known to be the thermal CVD), or alternatively the raw material gas becomes plasma by irradiating electromagnetic wave from a radio frequency coil (which is known to be the Plasma CVD) in order to deposit the anatase titanium oxide on the coating layer 32. The organic titanium compound as the raw material, including ethyl titanyl (Ti(OEt)₄)), isopropyl titanyl (Ti(OiPr)₄), and butyl titanyl (Ti(OBu)₄), may be decomposed at temperature in the range from 200 to 300° C.

Similar to the engraving process to form the groove 30 on the coating layer 32, the process of layering anatase titanium oxide is also performed prior to dicing the semiconductor wafer. In the layering process of anatase titanium oxide, the surface temperature of the wafer is in the range from 500 to 700° C. to crystallize the anatase compound.

As the pre-process of engraving the grove 30, the thin layer of anatase titanium oxide on the coating layer 32 accelerates the drainage of the sweat droplets into the groove 30.

As disclosed above, in the fabrication process of the semiconductor fingerprint image sensor, engraving the grooves on the thin film of anatase titanium oxide, which is layered on the coating layer, in a lattice structure aligning the grids between two adjacent electrodes, which determines the resolution of the acquired image, promotes drainage of droplets of sweat which is the cause of the residual fingerprint image to eliminate the residual fingerprint image from the surface of the semiconductor fingerprint image sensor, and hence prevents the residual fingerprint image from being used unintentionally.

### INDUSTRIAL FIELD OF APPLICATION

The present invention may provide a fingerprint image acquisition sensor that eliminates the pattern of the residual fingerprint effectively to prevent the residual fingerprint image on the sensor surface from being used maliciously.

### EXPLANATION OF REFERENCE NUMERALS

1—grid
2—electrode
3—solid substrate
4—water droplet
5—wetting angle
13—control unit
14—connection terminals with peripheral circuits
20—acquired fingerprint image
21—enlarged image of part of acquired fingerprint image
22—sweat gland
23—ridge
24—valley
30—groove
31—semiconductor substrate
32—coating layer
33—anatase titanium layer

What is claimed is:

1. A fingerprint image sensor, comprising:
a coating layer on the surface of a semiconductor fingerprint image acquisition sensor,
where there are horizontal and vertical grooves identical to the pattern of the grid lines which separates each electrode of the minimum functional unit of the sensor, formed on the sensor surface for draining the sweat droplets which forms a residual fingerprint into the grooves to eliminate the residual fingerprint image.

2. A fingerprint image sensor, comprising:
a coating layer on which a thin film of anatase titanium oxide additionally deposited and formed horizontal and vertical grooves identical to the grid lines of the sensor for draining the sweat droplets which forms a residual fingerprint into the grooves to eliminate the residual fingerprint image effectively.

3. The fingerprint image sensor of claim 1 or claim 2, wherein:
the grooves may be formed in either the horizontal or the vertical direction for swiping the drained water more easier.

4. The fingerprint image sensor of claims 1 to 3, wherein:
the grid line is held at zero electrical potential for electrically undetecting the drained sweat fluid into the groove.
